(19) United States
(12) Patent Application Publication
(10) Pub. No.: US 2004/0000737 A1
(43) Pub. Date: Jan. 1, 2004

(54) Method of manufacturing energy absorbent vehicle components

(76) Inventor: Nicole Durr, London (GB)

Correspondence Address: MCHALE & SLAVIN, 4440 PGA BLVD, SUITE 402, Palm Beach Gardens, FL, 33410, US

(21) Appl. No.: 10/186,232

(22) Filed: Jun. 28, 2002

(51) Int. Cl. B29C 44/06

(52) U.S. Cl. 264/46.6; 264/255; 264/240

(57) ABSTRACT

An improved vehicle component constructed with a rigid shell having a soft outer covering which absorbs impacts and disperses energy thereby protecting occupants of a vehicle. A method of vehicle component construction formed from injecting polyurethane into a top vented split mold having a shell positioned within the mold wherein the process sandwiches the shell there between to provide an external protective cushion.

### FIELD OF INVENTION

This invention relates to vehicle safety and in particular to a method of manufacturing interior and exterior vehicle components capable of improved impact protection for occupants.

### BACKGROUND OF THE INVENTION

The potential for an individual suffering an injury while an occupant of a motor vehicle is obviously dependant upon numerous factors. For this reason, laws mandate certain basic protective items and individual vehicle manufacturers employ numerous safety items all in an effort to protect the occupants. Such protective items include seat beats, air bags, roll cages, head rests, safety glass, collapsible steering wheels, padded dash boards, and so forth in an effort to protect the occupants during impact.

It should also be noted that there is range of protection afforded by each safety item. For instance, seat belts maintain an occupants torso in position, if worn, but fail to protect an unbuckled occupant. Air bags provide protection in high impact situations although in some situations the deployment of an air bag may cause more injury than the actual impact. Roll cages prevent crushing of the occupant area during a roll over. Head rests, if properly positioned, may prevent whiplash or otherwise inhibit rearward movement of an individuals head during impact. Safety glass may prevent pieces of glass from injuring the occupants. Collapsible steering wheels may lessen frontal impact to a driver. Padded dash boards help during low speed impacts. Thus, each safety item typically includes a range of speed that allows for proper operation and the more safety items included in a motor vechicle, the higher probability that a particular safety item will help during a collision. Unfortunately, a number of safety items are overlooked due to cost of manufacture, weight, or perceived insignificant assistance in protection. Thus, what is lacking in the art is a method of manufacturing conventional automobile components with an energy absorbing material that is low cost, does not affect weight, and simply adds to the area of protection. It is generally understood that any item of safety could assist during collision.

Energy absorbing materials for use in automobiles is not new. For instance, U.S. Pat. No. 5,932,331 discloses an automotive trim panel having a foam layer on each side of a shell, the shell having insufficient stiffness to retain a particular shape without the addition of the foam layers. The panel is formed from two laminated layers of thermoformable foam, each layer having a density that is different from the other layer.

U.S. Pat. No. 3,816,234 discloses an impact absorbing laminate. This impact absorbing foam has a finishing layer attached to the foam, the finishing layer being a mixture of ground impact absorbing foam.

U.S. Pat. No. 6,287,678 discloses a composite structural panel for use with various interior components such as door panels and head liners. The patent is directed to a composite structure having natural fibers fusion bonded to a core layer.

U.S. Pat. No. 6,136,415, is directed to a foam layer used on interior trim such as a vehicle dashboard and head liner. The structure is covered with a polyolefin foam layer to provide impact absorbing properties.

U.S. Pat. No. 6,080,469 discloses a laminated foam sheet for a vehicle interior wherein a PPE film layer is laminated on one side of a polyphenylene resin foam core and a polystyrene resin film layer is laminated on each side of the core.

U.S. Pat. No. 5,786,394 discloses the use of a polyolefin molded part surrounded on at least one surface by a layer of skin polyurethane flexible foam. The encasing of skin polyurethane foam retains energy absorption yet allowing parts to be bent without breakage.

U.S. Pat. No. 5,040,335 discloses the use of hollow boxes formed integrally with the panel door for absorbing side impact energy.

U.S. Pat. No. 5,985,096 discloses a seat back shell having a foam and skin layer attached thereto.

U.S. Pat. No. 5,089,328 discloses a lightweight panel having a foam backed cover with a compound which when activated stiffens the impregnated layer.

Accordingly, what is proposed is a method of manufacturing a vehicle component that is inexpensive, provides superior protection and weight advantages, and provides yet another area for protection of vehicle occupants and pedestrians who are involved in a motor vehicle collision.

### SUMMARY OF THE INVENTION

The present invention teaches a method of manufacturing both interior and exterior vehicle components with a unique energy absorbent material.

The vehicle component can be made of a conventional shape for its desired application such as a rear view mirror, head rest, seat, glove box cover, dashboard, shift lever, bumper, and so forth. The energy absorbent material is preferably created through an injection molding process having a proprietary flexible polyurethane foam that provides a coating of uniform consistency. For instance, a bumper for a vehicle can be formed by placement of a flexible polycarbonate shell within a split mold in such a manner so as to allow the foam material to cure around each side of the shell wherein the padding is evenly distributed on each side surface of the liner. The shell is made stiffer by the coating. However, should a pedestrian be struck by an automobile having a bumper formed from the construction of the instance invention, the effect would be as if the pedestrian was wearing padding. The coating on both sides of the support structure further enhances protection by effectively doubling the thickness of the padding.

For example, should a rear view mirror be forming in accordance with the method of manufacture, should an occupant strike the mirror, the coating on the mirror would absorb part of the impact as if the occupant was wearing padding. If the mirror impacts a solid surface, such as the window, the foam on the window side provides additional padding by effectively doubling the thickness of the pad.

The rear view mirror example involves coating of the entire assembly including the rotatable hinge. The coating providing flexiblity for such encasment without defeating the safety properties.

In production, a shell, such as a polycarbonate base, are placed as a unit into a preformed split mold housing. The internal cavity of the split mold is contoured to follow the outer shape of a desired protective vehicle component. After insertion, the shell is stabilized in a fixed position such as by the use of positioning rods inserted through the exterior walls of the mold. The rods extend through the rigid shell and flexible liner to abut the support base. The positioning rods ensure that, during the molding process, the liner and rigid shell remain in a desired orientation within the internal cavity of the mold.

A predetermined amount of polyurethane is then injected into the mold to fill the area bounded by the liner and the interior cavity of the mold. The spacing posts that separate the shell from the liner allow the injected polyurethane to flow around each side surface of the shell. Preferrably the rigid shell is perforated allowing the polyurethane to pass through the shell to provide an inseparable attachment between the inner and outer surfaces. Once the polyurethane is cured, the split mold is opened and the base, liner, and newly-formed vehicle component are removed, collectively, from the mold. The liner and vehicle component are then simultaneously separated from the rigid base. The outer surface of the vehicle component can be coated with paint, Teflon or most any other coating to provide a smooth finish.

Accordingly, it is an objective of the present invention to provide a vehicle component with a soft, energy absorbent covering on its outer surfaces.

Still another objective of the present invention to provide a vehicle component that is lighter and safer than the conventional vehicle components currently employed.

It is yet another objective of the present invention to provide a vehicle component with a soft, energy absorbent material molded entirely around the inner and outer surfaces of a rigid or semi-rigid vehicle component shell.

It is a related objective of the present invention to provide a vehicle component with a soft, energy absorbent material molded around an inner web of structural support material.

It is also an objective of the instant invention to disclose a process of manufacturing a padded vehicle component having a soft, energy absorbing covering on its outer and inner surfaces with a rigid shell formed integral there between.

Another objective of the instant invention is to disclose a padded vehicle component that can be inexpensively produced in mass quantity providing an affordable alternative to existing rigid components for use by the general public.

Yet still another objective of the instant invention is to disclose a padded vehicle component that has a malleable surface which can be coated with an impact resistant coating that can prevent rotational acceleration by providing a slick surface.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objectives and features thereof.

### BRIEF DESCRIPTION OF THE DRAWINGS

FIG. 1 is a perspective view of a rear view mirror vehicle component with a cutout illustrating the component shell;

FIG. 2 is a partial cross sectional side view of an encapsulated rear view mirror;

FIG. 3 is an exploded view of the components used cooperatively to form the injection molded embodiment of the present invention.

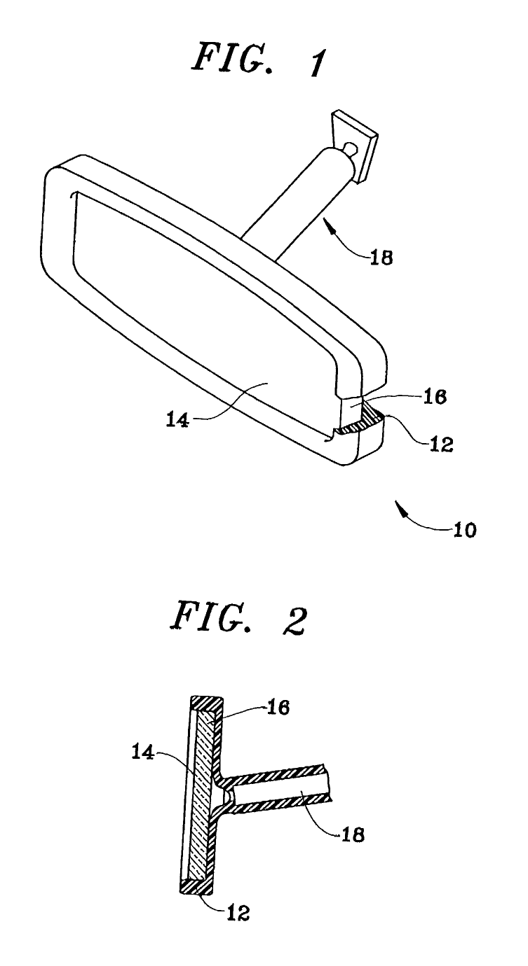

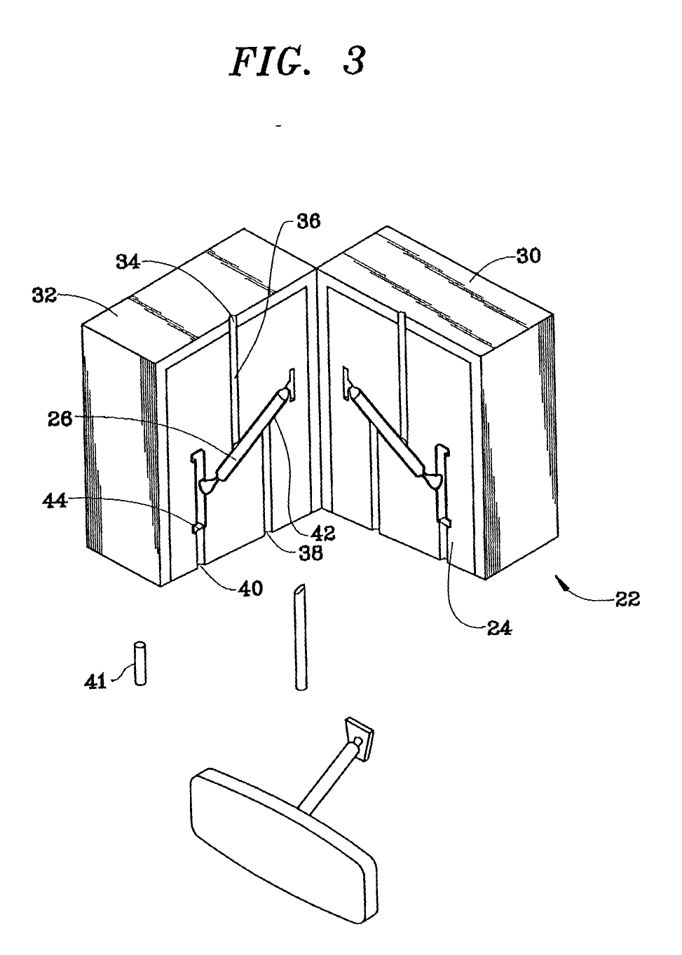

### DETAILED DESCRIPTION OF THE PREFERRED EMBODIMENT

Although the invention will be described in terms of a specific embodiment, it will be readily apparent to those skilled in this art that various modifications, rearrangements and substitutions can be made without departing from the spirit of the invention. For ease of illustration, a rear view mirror will be illustrated as an illustrative embodiment. It is well known that rear view mirrors include a movable joint which further illustrates the ability of the composition to encapsulate movable joints as well as fixed structures. The composition and method applicable to most any vehicle component. The scope of the invention is defined by the claims appended hereto.

Referring to the Figures in general, a rear view mirror 10 is illustrated having a cutaway 12 which shows the inner structure which in this embodiment is the mirror 14 with a rigid support shell 16 coupled to a window bracket 18. The outer material 20 provides the padded protection. The vehicle component is formed by the use of sealed cabinet 22 that has a rigid shell 24 that forms an injection chamber 26. The boundaries of the injection chamber 26 assimilate the vehicle component to be formed.

The base structure of the vehicle component is placed into the cabinet wherein the side enclosures 30 and 32 are closed in an arrangement to form a sealed cabinet. Liquid polyurethane of the type listed later in this specification, is forced into the injection chamber 26 through an injection conduit 34 that extends between the injection chamber 26 and the cabinet exterior. As the polyurethane flows into the injection chamber 26, the polyurethane expands to take the shape of the injection chamber boundaries. The flexible polyurethane foam is produced by reacting an organic polyisocyanate such as aliphatic cycloaliphatic, araliphatic, aromatic, or heterocyclic polyisocyanate. Support tubes 38 and 40 can be used wherein a dowel 41 is inserted for use in support of the vehicle component during the filling stage. Flexible liners 42 and 44 can further be used to assist in separating of the component or as a sealer wherein the foam expands within the chamber forcing the flexible liner away from the component and into a sealing position for support tubes 38 and 40.

The foam material used during prototype development is a polyurethane foam custom blended by Plast-O-Meric US, Inc. Of Sussex, Wis. and designated FF-3149XA. This foam is supplied in two parts called ISO and POLY. Metered amounts of ISO and POLY (typically 48 parts ISO to 100 parts POLY) are pumped under pressure to a blending nozzle and fed directly into the bottom of a top-vented mold. The foaming is a result of chemical reactions that begin when ISO meets POLY. These chemical reactions cause the mixture to heat up, foam and expand inside the mold cavity, and finally harden. As the mixture heats, foams, rises and finally hardens inside the mold air is being forced out through the vent holes, not shown, as the cavity fills with foam. Because the vent holes are relatively small (typically 0.1 inch in diameter) a positive back pressure develops inside the mold. This back pressure is important to insure a homogeneous foam density inside the mold and for proper skin formation. For example, the vehicle component products typically have a molded foam density of 2 to 3 times the free-rise foam density.

Because this is a dynamic process that takes only about 20 seconds, it is important to customize the POLY blend to the mold and vents being used. The ISO used in this application is a special quasi-prepolymer made for high performance foams. The ISO is typically an organic polyisocyanate such as aliphatic, cycloaliphatic araliphatic, aromatic or heterocyclic polyisocyanate.

The POLY is typically a blend of polyether polyols 93% chain extenders 4.55 tertiary amine catalysts 1%, organic metal compounds, emulsifiers and foam stabilizers, and blowing agents including HFC 13a, HFC 245 1% and water 0.5%.

The blend of polyether polyols typically include: polyoxypropylene diols, triols and tetrols; ethylene oxide capped diols, triols and tetrols; random and block polymers of diols, triols, and tetrols containing both ethylene and propylene oxides; copolymer polyols containing stable dispersions of solids; polyester polyols including ethylene glycol adipates, cross-linked diethylene glycol adipates, cross-linked 1,3-butylene glycol phthalate adipates, linear diethylene glycol adipates, 1,4-butanedial adipates, crosslinked dipropylene glycol phthalate adipates.

The chain extenders typically include: 1,4-butane diol; diethanolamine, triethanolamine; ethylene glycol; diethylene glycol, triethylene glycol; 1,2-butane diol, 1,3-butane diol; 1,2-pentane diol, 1,4-pentane diol, 1,5-pentane diol; 1,6-hexane diol; glycerol.

Tertiary amine catalysts typically include; triethylamine, tributylamine, N-methyl-morpholine, 1,4-diazabicyclo-(2,2,2)octane, bis-(N,N-diethylaminoethyl) adipate.

Organic metal compounds including: tin (II)-salts of carboxylic acids, dialkytin salts of carboxylic acids.

Emulsifiers and foam stabilizers including: sodium salts of castor oil sulfonates, diethanolamine stearate, watersoluble polyether siloxanes. Blowing agents including: water, HFC 134a, HFC 245, acetone, methylene chloride, cyclo pentane.

The polyurethane is allowed to cure, forming the vehicle component of the present invention. Once the polyurethane has cured, the cabinet is opened and the vehicle component, can be removed from the mold. A flexible liner can be used to assist in removal of the component wherein the flexible liner is peeled away from the newly-formed vehicle component.

Preferably, the polyurethane has a foam free rinse density of 10.5 pcf, a foam molded density of 23-27 pcf and, a foam molded hardness of 35-45 A SHORE. The polyurethane is a blend of a quasiprepolymer with a blend of polyether polyoys. More specifically, the pqlyurethane is formed from two components: a modified MDI quasiprepolymer and a blend of polyether polyoys. Materials are inserted by use of HCF 134 A as a blowing agent. Depending on the type of component to be formed, as the polyurethane cures, the mold 22 can be rotated to ensure even distribution of the injected polyurethane. During the rotation, the polyurethane solidifies to form the protective vehicle component. Once the polyurethane has cured completely, the rigid shell 16 is permanently concealed within the vehicle component increasing the structural integrity thereof.

It is to be understood that while a certain form of the invention is illustrated, it is not to be limited to the specific form or arrangement of parts herein described and shown. It will be apparent to those skilled in the art that various changes may be made without departing from the scope of the invention and the invention is not to be considered limited to what is shown in the drawings and descriptions.

What is claimed is:

1. A method of making a padded vehicle component comprising the steps of:
a) forming a top vented outer mold having an interior surface that bounds a chamber sized and shaped to assimilate a vehicle component outer surface, said outer mold disposed within a split mold housing;
b) forming a shell member, said shell member sized to fit within said outer mold;
c) forming a flexible liner shaped to follow at least a portion of the contours of an inner surface of said chamber;
d) temporarily securing said liner in a predetermined orientation within said outer mold;
e) injecting a predetermined amount of polyurethane into said mold, said predetermined amount being great enough to surround said shell member;
f) allowing said polyurethane to cure, forming a vehicle component sandwiched between said flexible liner and said outer mold interior surface;
g) removing said liner and said vehicle component from said mold; and separating said liner and said vehicle component.

2. The method of making a protective vehicle component of claim 1 wherein said liner and said at least one shell member are secured in said predetermined orientation by at least one rod inserted there into.

3. The method of making a protective vehicle component of claim 1 wherein said at least one shell member includes perforations sized and positioned to allow said polyurethane to flow therethrough.

4. The method of making a protective vehicle component of claim 1 wherein vent hole provides a positive back pressure inside said mold to insure a homogeneous foam density mixture within said mold

5. The method of making a protective vehicle component of claim 1 wherein the polyurethane of step (e) is produced by reacting approximately 48 parts ISO to approximately 100 parts POLY pumped under pressure to a blending nozzle and fed directly into the bottom of said top-vented mold.

6. The method of making a protective vehicle component of claim 5 wherein said ISO is from the organic polyisocyanate group aliphatic, cycloaliphatic araliphatic, aromatic or heterocyclic polyisocyanate.

7. The method of making a protective vehicle component of claim 5 wherein said POLY is a blend of polyether polyols 93% chain extenders 4.55 tertiary amine catalysts 1%, organic metal compounds, emulsifiers and foam stabilizers, and blowing agents.

8. The method of making a protective vehicle component of claim 7 wherein said blowing agents includes HFC 134a.
